(19) United States
(12) Patent Application Publication
(10) Pub. No.: US 2017/0284554 A1
(43) Pub. Date: Oct. 5, 2017

(54) DEAERATION VALVE

(71) Applicant: BorgWarner Sweden AB, Landskrona (SE)

(72) Inventors: Erik SKOLD, Malmö (SE); Oscar TEDENSTAD, Malmö (SE)

(21) Appl. No.: 15/506,897

(22) PCT Filed: Jul. 3, 2015
(86) PCT No.: PCT/EP2015/065242

§ 371 Date: Feb. 27, 2017

(30) Foreign Application Priority Data
Aug. 28, 2014 (SE) 1450998-8

(51) Int. Cl. F16K 24/04; F16K 1/46; F16D 25/12; F16K 31/122

(52) U.S. Cl. CPC F16K 24/04; F16K 31/1221; F16K 1/46; F16D 25/12; F16D 2121/04

(57) ABSTRACT

A deaeration valve (1) for a hydraulic coupling, such as a hydraulic coupling for distributing torque in a vehicle, said valve (1) comprising a valve member (3) and a valve housing (2), the valve housing (2) supporting the valve member (3) for reciprocal movement between two closed end positions.

### TECHNICAL FIELD

The present invention relates to a deaeration valve and a method for deaeration of a hydraulic system. More particularly, the invention relates to a deaeration valve for a hydraulic coupling, such as a hydraulic coupling for distributing torque in a vehicle.

### BACKGROUND

When implementing hydraulic systems in different applications, it is desired to provide venting functionality in order to remove any air that might be trapped in the system. Since air pockets in a hydraulic system risk worsening the accuracy and may even cause the system to fail, the ability to bleed the system from air is especially important.

Bleeding of for instance hydraulic systems for actuating the brakes of a car can be done manually by a technician by opening specific valves that let the air escape. However, in more complex systems being an integrated part of a vehicle, such as hydraulic coupling used for torque transfer, it may be desired to automatically bleed the system. This allows more frequent deaeration and removes the need for manual bleeding. Automatic bleeding of hydraulic systems is generally achieved by running specific bleed cycles, typically rising the pressure above normal operation pressure and above the opening pressure of a pressure relief valve in order to ensure that air is removed.

Since running specific deaeration cycles uses unnecessary energy and subjects the hydraulic system to a higher mechanical strain than normal operation, it is desired to be able to bleed the system during normal operating conditions without risking loosing pressure or leaking substantial amounts of oil from the system.

### SUMMARY

It is an object of the present invention to provide a deareration valve solving the above mentioned drawbacks of prior art systems. In particular, an object is to provide a deaeration valve for a hydraulic system of a hydraulic coupling. Furthermore, it is an object to present a deareration valve which can allow air to escape from the system without loosing pressure or significant amounts of hydraulic fluid or oil. It is also an object of the invention to provide a deaeration valve which allows air to escape from the system in the pressure interval of normal operation of the hydraulic system.

According to a first aspect of the invention a deaeration valve is provided for a hydraulic coupling, such as a hydraulic coupling for distributing torque in a vehicle. Said valve comprising a valve member and a valve housing, the valve housing supporting the valve member for reciprocal movement between an idle closed end position and an actuated closed end position, wherein the valve member is biased towards the idle closed end position, such that when the valve member is subjected to an increased pressure, pressurized air will be allowed to escape through the valve. The system can be bled as a part of normal operation of the hydraulic coupling and without losing substantial pressure or large amounts of oil from the system. As the pressure rises in the hydraulic system towards normal operation pressure, the valve member moves from the idle closed position to the actuated closed position, whereby air is able to pass during the movement of the valve member. During deactivation of the hydraulic system, the pressure drops below what is required for moving the valve member back to its idle closed position. In this way the system is bled at least twice during normal cycle of operation. Furthermore, by choosing the biasing force the opening and closing of the valve can be controlled and thereby also the pressure intervals at which the valve is open.

According to one embodiment, the deaeration valve further comprises a fluid passage extending between an inlet port and an outlet port of the valve housing, one of said ports being closed when the valve member is in its idle closed position, wherein when the valve member is subjected to an increased pressure, the closed port is at least partly opened for allowing a flow of fluid through said fluid passage. By providing a valve which closes as the system is idle, i.e. when the valve member is in the idle closed position, it is ensured that no oil escapes when the system is unpressurized and that no air can flow into the system. Furthermore, by the opening of the inlet port as the pressure rises, air can escape from the system when the system is pressurized.

According to a further embodiment a spring is provided for biasing the valve member towards the idle closed position. Hence it is ensured that no oil escapes when the system is unpressurized, and that no air is allowed to flow into the system. Further, reliable mechanical biasing can be provided such that the pressure required to open the valve can be controlled.

According to another embodiment the spring is arranged to act in a direction being opposite the direction of the force corresponding to the fluid pressure acting on the valve member. The movement of the valve member can thus be controlled in relation to the pressure and the fluid forces which may be acting on the valve member.

According to one further embodiment the biasing force of the spring is less than the force being applied to the valve member by means of hydraulic fluid when an associated hydraulic coupling is operated at maximum pressure, such that the valve is adapted to let the pressurized air escape through the valve when the oil pressure that acts on the valve member is within the normal range of operation for the hydraulic coupling. This enables that the hydraulic coupling can be bled or deaerated during operation of said coupling, whereby the need for deaeration cycles raising the pressure above normal operation pressure or similar is eliminated. Also, regular bleeding of the system is provided since the valve will open at least once each time the pressure rises above the required pressure for opening the valve.

According to another embodiment said valve member comprises a sealing member for closing an outlet port of the valve housing when the valve member is positioned in the idle closed position. The sealing member allows the valve to be sealed while the strength of the biasing force required to keep the valve closed, when the valve member is in the idle closed position, can be decreased. This also leads to that a lower opening pressure, i.e. when the valve member starts to move away from the idle closed position, can be attained. The sealing member could for example be a seat for allowing a tight fit between two mating surfaces. The mating surfaces could e.g. be made of metal or any other material suitable for the particular application.

According to another embodiment said sealing member is an O-ring.

According to a further embodiment the deaeration valve further comprises a guiding member being connected to the valve member at a first end thereof, wherein said sealing member is provided between the guiding member and the valve housing such that pressurized air is allowed to leak through the sealing member. The guiding member keeps the valve member arranged in the correct alignment with the valve housing. Additionally, by providing the guiding member with the sealing member, the air needs to pass the sealing member in order to be able to escape from the valve and out of the hydraulic system.

According to another embodiment said guiding member is slidably connected to the valve housing, and the outlet port of the valve housing is arranged radially outside the guiding member. This allows the pressurized air to escape through the outlet port(s) by passing through or past the sealing member and the guiding member.

According to a further embodiment the valve member has, at its second end, a flange protruding outside said valve housing for engagement with the inlet port of the valve housing when the valve member is arranged in the actuated closed position. This provides a deaeration valve which closes once the valve member reaches the actuated closed position, which occurs when oil starts to leak through the valve before the hydraulic coupling reaches the maximum operating pressure. r.

According to one embodiment the flange has a conical shape, and the inlet port of the valve housing has a corresponding conical shape. This provides a valve member that is easy to manufacture and that provides a sealed connection between the valve member and the valve housing when the valve member is in the actuated closed position. The valve housing could in some embodiments have a shape being different from conical, as long as the shape of the valve housing and the shape of the valve member are configured to mate with each other.

According to a further embodiment a slit is formed between the valve member and the valve housing, said slit being dimensioned such that air may flow freely through the slit, and such that hydraulic fluid, such as oil, when flowing through the slit, will increase the friction between the valve member and the hydraulic fluid to such extent that the friction is higher than the biasing force to which the valve member is exposed. By providing a valve comprising a slit according to the above, the valve member is affected by any oil or hydraulic fluid flowing past having a significantly higher viscosity than air, such that the valve member moves to the actuated closed position and closes the valve. Any substantial oil leak through the valve may thus be prevented.

According to another embodiment the valve member has a first end for closing the inlet port when the valve member is in the idle closed end position, and a second end for closing the outlet port when the valve member is in the actuated closed end position, and an intermediate portion connecting said first end with said second end. By providing a deaeration valve wherein the valve member is arranged to close the valve with the two ends thereof, the position of the valve member will determine the state of the deaeration valve. Furthermore, by adapting the shape of the first and second end and the dimensions of orifices in the valve housing connected to the outlet and inlet ports, a specific characteristic of the valve can be attained.

According to a further embodiment the first end has an essentially spherical shape and the second end has an essentially spherical shape, and the radius of the first end is smaller than the radius of the second end. By the valve member having different radiuses on the first and second end, the orifices in the valve housing that is connected to the outlet and inlet ports can be dimensioned accordingly. This results in that the force generated by the pressure acting on the valve member can be controlled in relation to the size of the orifices.

According to one embodiment the deaeration valve comprises a slit being formed between the intermediate portion and the valve housing for allowing pressurized air to flow freely from the inlet port to the outlet port when the valve member is moving from the idle closed end position towards the actuated closed end position. By providing a slit, the air that is trapped inside the hydraulic system can escape when the valve member is between the two closed positions. Furthermore, the valve member is affected by any oil or hydraulic fluid flowing past having a significantly higher viscosity than air such that a force is generated that in cooperation with the pressure acting on the valve member moves the valve member to the actuated closed position and closes the valve.

According to a further embodiment the deaeration valve is configured to open for letting pressurized air pass when the pressure on the inlet port is in the range of 5-40 bar, whereby the valve member moves from its idle closed end position to the actuated closed end position.

According to another embodiment the valve member is configured to return from the actuated closed end position to the idle closed end position when the pressure falls by approximately a factor 2-10 relative the pressure required for opening of the valve. Thus is it possible to ensure that the valve member is kept in the actuated closed position during the normal operation of the hydraulic coupling such that no substantial oil leak occurs. I.e. the valve member moves from the idle closed position to the actuated closed position as the hydraulic system is activated and the pressure rises and when the pressure subsequently drops by a factor 2 to 10 in relation to the opening pressure, the valve member moves in the opposite direction to the idle closed position. Thereby the valve is opened twice during a cycle of increasing and decreasing the pressure in the hydraulic system.

According to a further embodiment the ratio of the surface area of the valve member that the air pressure is acting on via the inlet port when the valve member is in its idle closed position and its actuated closed position, respectively is approximately 2 to 10.

According to a second aspect, a hydraulic coupling is provided. The hydraulic coupling comprises a deaeration valve according to the first aspect presented above.

According to a third aspect, a method for deaeration of a hydraulic system for a hydraulic coupling, such as a hydraulic coupling for distributing torque in a vehicle, is provided. The method comprises the step of providing a valve having a valve member and a valve housing, the valve housing supporting a valve member for reciprocal movement between two closed end positions, wherein the valve member is biased towards one of said closed end positions. The method further comprises the step of subjecting the valve member to an increased pressure whereby pressurized air will be allowed to escape through the valve.

### BRIEF DESCRIPTION OF DRAWINGS

The invention will be described in further detail below under reference to the accompanying drawings, in which

FIG. 1 is a cross-sectional view of a hydraulic coupling according to an embodiment,

FIG. 2 is a cross-sectional view of a deaeration valve according to one embodiment,

FIG. 3 is a cross-sectional view of a deaeration valve according to one embodiment, and

FIG. 4 is a schematic view of a method according to an embodiment.

### DETAILED DESCRIPTION

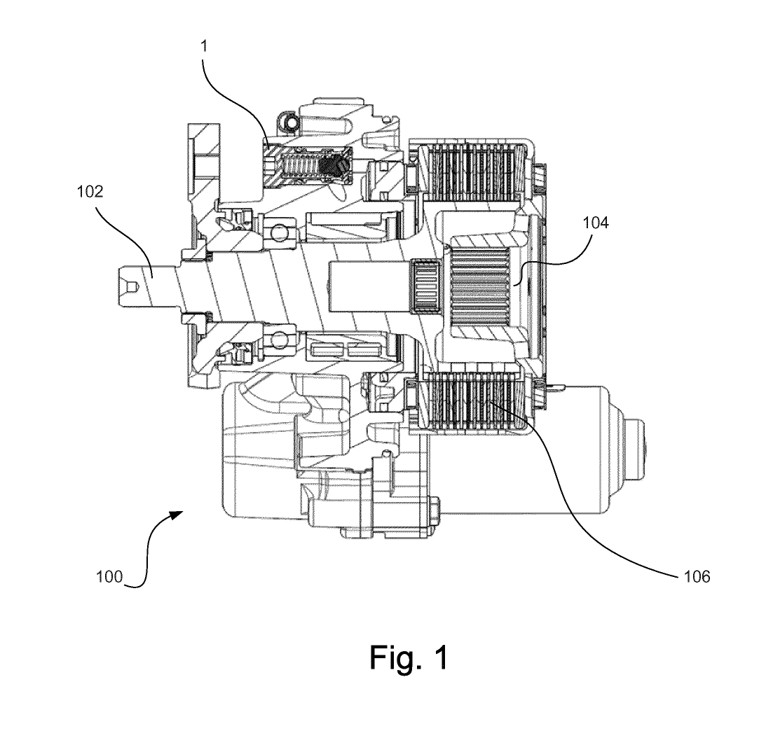

A hydraulic coupling 100 for transferring torque, such as driving torque, in a vehicle is shown in FIG. 1. The hydraulic coupling 100 comprises an input shaft 102, an output shaft 104, and a disc package 106 having a first set of discs in connection with the input shaft 102 and a second set of discs in connection with the output shaft 104. Once actuated by means of hydraulic pressure applied to a piston, the disc package 106 will be compressed such that input torque will be transferred to the output shaft 104. The disc package 106 is enclosed within a disc drum receiving hydraulic fluid for cooling and lubrication. In order to allow entrapped air to escape out from the disc drum, a deaeration valve 1 is provided at the highest point of the hydraulic system.

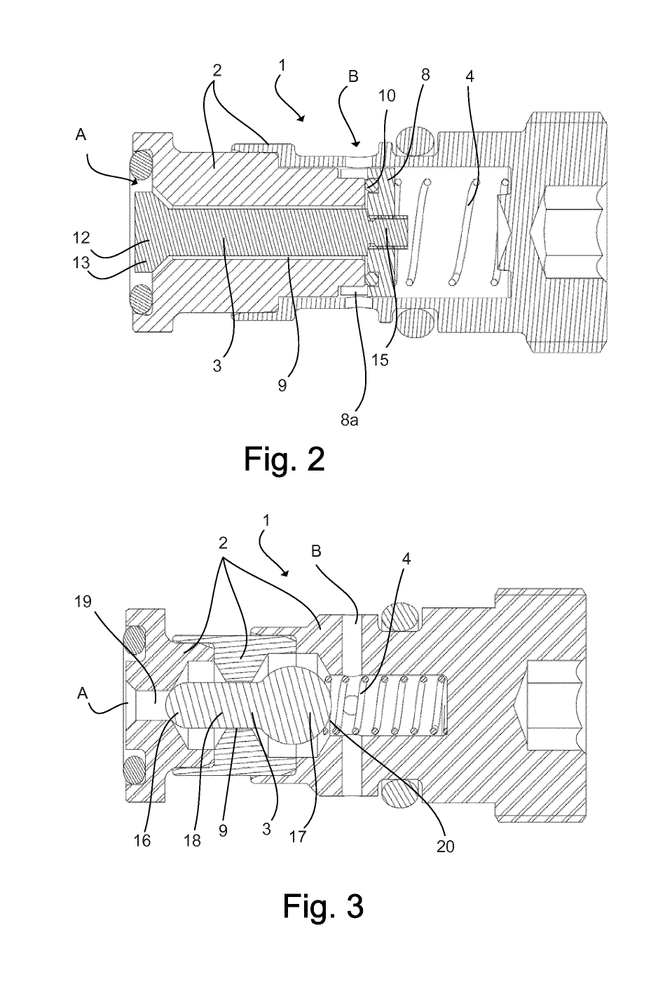

FIG. 2 shows a deaeration valve 1 according to one embodiment in more detail. The valve 1 is adapted to be mounted to a hydraulic system, especially a hydraulic system in a hydraulic coupling distributing the torque between the different wheels of a vehicle as is shown in FIG. 1. The valve 1 comprises a valve member 3 arranged inside a valve housing 2 for reciprocal motion within said housing 2. The valve member 3 may move reciprocally between an idle closed end position and an actuated closed end position. The valve member 3 is biased towards the idle closed end position by e.g. a spring 4, and the pressure from the hydraulic fluid acts in the opposite direction towards the actuated closed end position. In FIG. 2, the valve 1 is shown in the idle closed position.

The valve housing 2 may comprise one or several parts or portions, each being connected to form a support for mounting the valve 1 to a hydraulic system, and the valve member 3 to the valve housing 2, and for supporting the valve member 3 for reciprocal motion within said housing 2.

The reciprocal motion of the valve member 3 is limited by the contact of the two ends 12, 15 of the valve member 3, directly or indirectly through means for sealing 10, with the valve housing 2. When the valve member 3 is positioned between the two closed end positions, the valve 1 is open for letting air escape from the hydraulic system through the valve 1.

The first end 15 of the valve member 3 may comprise a thereto attached guiding member 8, for sliding contact with the inside of the valve housing 2. Furthermore, the guiding member 8 may comprise a sealing member 10, such as an O-ring or similar, which comes into sealing contact with the valve housing 2 when the valve member 3 is in the idle closed end position. When the pressure is increased, pressurized air will be able to escape through or past the sealing member 10. The guiding member 8 may further comprise radial holes or orifices 8a which allows air to escape through these, and onwards through one or several outlet ports B in the valve housing 2, when the valve member 3 is between the two closed positions. The air may also escape through the intermediate space that is formed due to tolerances between the guiding member 8 and the valve housing 2.

The second end 12 of the valve member 3 is facing towards the hydraulic coupling, said end 12 having a flange 13 protruding outside the valve housing 2 and is arranged for engagement with the inlet port A of the valve housing 2 when the valve member is in the actuated closed position. The flange 13 may have a conical shape and the inlet port A of the valve housing may have corresponding conical shape for sealing contact between the two when the valve member is in the actuated closed position. The shapes of the contacting surfaces 13, A are however not limited to the conical shape, any shapes exhibiting a mutually sealing function is applicable.

Between and connecting the two ends 12, 15 of the valve member 3 is an elongated cylindrical intermediate portion, having a radius slightly smaller than a corresponding cylindrical bore in the valve housing 2. A cylindrical slit 9 is defined by the space formed between the cylindrical portion of the valve member 3 and the valve housing 2. The slit 9 has a sufficiently large cross-sectional area, being dimensioned such that air may flow freely through the slit 9.

The valve 1 further comprises means for biasing 4, such as a spring, in order to bias the valve member 3 towards its idle closed position. This assures that the valve 1 is sealed when the hydraulic system is unpressurized, leaving no possibility for air or hydraulic fluid to be transported through the valve 1. However, air is still allowed to enter the valve 1 through the open inlet port A. When the valve member 3 is subjected to an increased pressure from the hydraulic system, pressurized air may escape through or past the sealing member 10 until the valve member 3 reaches the actuated closed end position. The mechanism for this may be that the sealing means 10 is only sufficiently compressed by the means for biasing 4 such that the valve 1 only is sealed (when the valve member 3 is in the idle closed position) when the valve member 3 is unaffected by pressure, but as soon as the pressure rises, air may pass through or past the sealing means 10. Alternatively, the valve 1 may be configured such that the means for biasing 4 needs to be slightly compressed by a rising pressure affecting the valve member 3 before air can escape, by the valve member 3 moving towards its actuated closed end position and thereby removing the sealing contact between the sealing member 10 and the valve housing 2. The characteristics of the opening of the valve 1 can be controlled by varying the strength of the means for biasing 4.

The valve 1 may open for letting pressurized air pass when the pressure rises above 0 bar (g) whereby the sealing contact or contact pressure between the sealing member 10 and the valve housing 2 is gradually decreased as the hydraulic pressure rises. The valve member 3 reaches its actuated closed end position when the pressure rises to approximately 0.5 bar (g). In a preferred embodiment, the valve 1 will be open for letting air escape in the pressure interval 0<p≦0.3 bar (g). When the pressure rises above the mentioned pressure intervals, the valve member 3 will be positioned in the actuated closed end position in which the second end 12 of the valve member 3 is in sealing contact with the valve housing 2. Ideally, the pressure interval in which the valve 1 is opened and closed is within the pressure range of normal operation of the hydraulic system to which the valve 1 is connected. Ideally the valve 1 is adapted to be opened as pressure rises in the system, and closed once it exceeds a specific pressure, maintaining a closed position during normal operation until the pressure drops below a specific pressure whereby the valve briefly opens as the valve member 3 moves from one closed position to the other.

The valve member is affected towards the actuated closed position in essentially two different ways, one being the pressure from the hydraulic system acting on the valve member 3 and the other being the viscosity of the hydraulic fluid that enters the slit 9 which generates fluid forces that acts on the valve member 3 towards the actuated closed end position. The friction that is generated between the fluid and the valve member 3 as the fluid tries to flow through the slit 9 generates a sufficient force in order to close valve 1, thereby minimizing the amount of hydraulic fluid that passes through the valve 1.

By positioning the valve 1 in the highest point of the hydraulic system, such as indicated in FIG. 1, any air that is trapped in the system is likely to be adjacent to the valve 1 when it opens. Due to the fact that air is has a lower viscosity than hydraulic fluid, it will be able to pass quickly without much resistance during the movement of the valve member 3 from the idle closed end position to the actuated closed end position, without letting any or only a small amount of the hydraulic fluid escape. By providing a valve 1 according to the present invention, the hydraulic system can be bled during normal operation and without any significant pressure drop or loss of hydraulic fluid.

FIG. 3 shows a deaeration valve 1 according to a further embodiment. The valve 1 is adapted to be mounted to a hydraulic system, especially a hydraulic system for a hydraulic coupling distributing the torque between the different wheels of a vehicle. Hence, the valve 1 of FIG. 3 is suitable for a hydraulic coupling 100 as is shown in FIG. 1. The valve comprises a valve member 3 arranged inside the valve housing 2 for reciprocal motion within said housing 2 between two closed end positions. The valve housing 2 can comprise several parts or portions, each being connected to form the base for mounting the valve 1 to a hydraulic system and the valve member 3 to the valve 1.

Furthermore, the valve member 3 has a first end 16 for closing the inlet port A when the valve member 3 is in the idle closed end position, and a second end 17 for closing the outlet port B when the valve member 3 is in the actuated closed end position, and an intermediate portion 18 connecting said first end 16 with said second end 17.

The reciprocal motion of the valve member 3 is limited by the contact of the two ends 16, 17 of the valve member 3 with the seats of the valve housing 2. When the valve member 3 is positioned between the two closed end positions, the valve 1 is open for letting air escape from the hydraulic system through the valve 1.

The two ends of valve member 3 are essentially spherically shaped, the first end 16 having a smaller radius than the second end 17. Other shapes can also be applied that exhibits similar properties and are appropriate for sealing contact with the valve housing 2. The two spherical ends 16, 17 are connected by an intermediate portion 18, said intermediate portion having preferably a cylindrical shape. The radius of the intermediate portion 18 is approximately equal to the radius of the spherical portion of the first end 16.

The intermediate portion 18 may come into sliding contact with the valve housing 2 such that it supports the valve member 3 during its reciprocal motion inside the valve housing 2. However, it is preferred that the intermediate portion 18 is dimensioned such that a small slit 9 is formed between the intermediate portion 18 and the valve housing 2. During the movement of the valve member 3 it is thereby centralized by the fluid flowing in the slit 9 such that no contact occurs between the intermediate portion 18 and the valve housing 2. Thus, the intermediate portion may have a slightly smaller radius than the adjacent corresponding surface in the valve housing 2, thereby forming the slit 9 for allowing air to pass through the valve 1 when the valve member 3 is between the idle closed end position and actuated closed end position. Alternatively or in combination, the intermediate portion 18 of the valve member 3 may have a slightly decreasing radius towards the second end 17 of the valve member, i.e. a tapered surface which is in contact with the valve housing 2 when the valve member is in the idle closed end position and that provides for creation of a small slit 9 for passage of air when the valve member is not in the idle closed end position.

The valve 1 further comprises means for biasing 4, such as a spring, in order to bias the valve member 3 towards sealing contact between the first end 16 and the valve housing 2, more specifically at an orifice 19 forming the inlet port A in the valve housing 2. This assures that the valve 1 is sealed or closed when the hydraulic system is unpressurized, leaving no possibility for air or hydraulic fluid to be transported through the valve 1.

When the valve member 3 is in the actuated closed position, the second end of the valve member 17 abuts against an orifice 20 in the valve housing 2 connected to an outlet port B of said valve 1 closing the valve 1 such that no air or fluid can escape.

Due to the shape of the valve member 3 and the size of the orifice 19 connected to the inlet port A and the orifice 20 connected to the outlet port B, a specific pressure ratio can be attained for the opening and closing of the valve 1 respectively. When the valve member is in the idle closed position, the pressure acts only on the small area of the valve member 3 defined by the orifice 19. Therefore a relatively high pressure is needed for opening of the valve 1 in comparison with the pressure needed for maintaining an open valve 1.

The lower pressure needed for maintaining an open valve 1 is achieved by that when the valve member 3 starts to move towards the actuated closed position, the pressure from the hydraulic system is allowed to act on a larger surface area, thereby generating a higher force pushing the valve member 3 towards the actuated closed end position. When in the actuated closed end position, the second end 17 abuts against the orifice 20 which is larger than the orifice 19 connected to the inlet A. Since only ambient pressure, i.e. atmospheric pressure will act against the large surface area on the valve member 3 that is defined by the second end 17 abutting against the orifice 20, the resultant force from the pressure acting on the valve member 3 is higher in relation to an equal pressure acting on the valve member 3 when in the idle closed end position.

In one embodiment, the radius of the intermediate portion 18 is smaller than the radius of the orifice 20.

In one embodiment the valve 1 is open for letting pressurized air pass when the pressure on the inlet port A is within normal operating conditions of the associated hydraulic system, such as in the range of 5-40 bar(g), whereby the valve member 3 moves from its idle closed end position to the actuated closed end position. During the movement, pressurized air is allowed to escape while the hydraulic fluid, which generates a higher fluid resistance while flowing through the slit 9, will not escape in any significant amount, if any.

In one embodiment the valve 1 is opened for letting pressurized air pass when the pressure on the inlet port A rises above 15 bar(g) and, whereby the valve member 3 moves from its idle closed end position to the actuated closed end position.

In one embodiment the valve 1 is opened for letting pressurized air pass when the pressure on the inlet port A having previously risen above 15 bar(g) and then subsequently falls below 3 bar(g), whereby the valve member 3 moves from its actuated closed end position to the idle closed end position.

I.e. after being opened, the valve member 3 is configured to return from the actuated closed end position to the idle closed end position when the pressure falls by approximately a factor 2-10 relative the pressure required for opening of the valve 1.

The ratio of the surface area of the valve member 3 that the air pressure is acting on via the inlet port A when the valve member 3 is in its idle closed position and its actuated closed position, respectively is approximately 2 to 10.

I.e. the valve requires a higher pressure to open than to close since the area of the valve member 3 that is subjected to the rising pressure while in the idle closed end position is small in relation to the surface area affected by the pressure in the actuated closed position. Furthermore, since the orifice 20 connected to the outlet port B is substantially larger than the orifice 19 connected to the inlet port A, a large portion of the surface area of the valve member 3 will be affected only by the atmospheric pressure when in the actuated closed position. This results that the surface area of the valve member 3 that the air and/or fluid pressure is acting on via the inlet port A when the valve member 3 is in its idle closed position and its actuated closed position, respectively is approximately 2 to 10. The characteristics of the biasing means 4 and the travel distance between the two closed end positions of the valve member 3 also affects the opening/closing of the valve 1.

Furthermore, since any arbitrarily shaped body that is affected homogeneously by a pressure from its surrounding generates no resulting force in any direction; this effect can be used to ensure that mainly air can escape through valve 1. Since air flows more or less freely through the slit 9 after the valve member 3 has started to move from its idle closed position, the pressure will equalize rapidly around the valve member 3. However, as soon as oil or fluid having a significantly higher viscosity than air is introduced into the slit 9, the flow resistance will increase through the slit 9, which creates a pressure gradient in the axial direction of the slit 9 with a resulting lower pressure zone around the second end 17 and a high pressure zone around the first end 16. The oil also generates a friction force acting on the valve member 3 by the oil trying to flow past it. Thereby is a higher force generated when fluid or hydraulic oil is introduced into the slit 9, which acts to force the valve member 3 towards its actuated closed position.

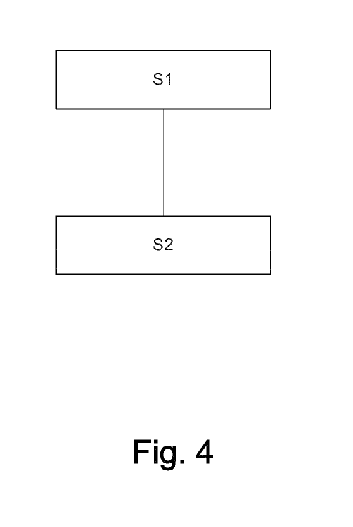

Furthermore, as is shown in FIG. 4 a method for deaeration of a hydraulic system for a hydraulic coupling is presented. The hydraulic system may e,g. be a hydraulic coupling for distributing torque in a vehicle, and the method comprises the step S1 of providing a valve having a valve member 3 and a valve housing 2, the valve housing 2 supporting a valve member 3 for reciprocal movement between two closed end positions, wherein the valve member 3 is biased towards one of said closed end positions. Further, the method comprises the step S2 of subjecting the valve member 3 to an increased pressure whereby pressurized air will be allowed to escape through the valve 1.

1. A deaeration valve for a hydraulic coupling, such as a hydraulic coupling for distributing torque in a vehicle, said valve comprising a valve member and a valve housing, the valve housing supporting the valve member for reciprocal movement between an idle closed end position and an actuated closed end position, wherein the valve member is biased towards the idle closed end position, such that when the valve member is subjected to an increased pressure, pressurized air will be allowed to escape through the valve.

2. The deaeration valve according to claim 1, further comprising a fluid passage extending between an inlet port and an outlet port of the valve housing, one of said ports being closed when the valve member is in its idle closed position, wherein when the valve member is subjected to an increased pressure, the closed port is at least partly opened for allowing a flow of fluid through said fluid passage.

3. The deaeration valve according to claim 1, further comprises a spring for biasing the valve member towards the idle closed position.

4. The deaeration valve according to claim 3, wherein the spring is arranged to act in a direction being opposite the direction of the force corresponding to the fluid pressure acting on the valve member.

5. The deaeration valve according to claim 3, wherein the biasing force of the spring is less than the force being applied to the valve member by means of hydraulic fluid when an associated hydraulic coupling is operated at maximum pressure, such that the valve is adapted to let the pressurized air escape through the valve when the oil pressure that acts on the valve member is within the normal range of operation for the hydraulic coupling.

6. The deaeration valve according to claim 1, wherein said valve member comprises a sealing member for closing an outlet port of the valve housing when the valve member is positioned in the idle closed position.

7. The deaeration valve according to claim 6, wherein said sealing member is an O-ring.

8. The deaeration valve according to claim 6, further comprising a guiding member being connected to the valve member at a first end thereof, wherein said sealing member is provided between the guiding member and the valve housing such that pressurized air is allowed to leak through the sealing member.

9. The deaeration valve according to claim 8, wherein said guiding member is slidably connected to the valve housing, wherein the outlet port of the valve housing is arranged radially outside the guiding member.

10. The deaeration valve according to claim 6, wherein the valve member at its second end has a flange protruding outside said valve housing for engagement with the inlet port of the valve housing when the valve member is arranged in the actuated closed position.

11. The deaeration valve according to claim 10, wherein the flange has a conical shape, and wherein the inlet port of the valve housing has a corresponding conical shape.

12. The deaeration valve according to claim 6, wherein a slit is formed between the valve member and the valve housing, said slit being dimensioned such that air may flow freely through the slit, and such that hydraulic fluid, such as oil, when flowing through the slit, will increase the friction between the valve member and the hydraulic fluid to such extent that the friction is higher than the biasing force to which the valve member is exposed.

13. The deaeration valve according to claim 1, wherein the valve member has a first end for closing the inlet port when the valve member is in the idle closed end position, and a second end for closing the outlet port when the valve member is in the actuated closed end position, and an intermediate portion connecting said first end with said second end.

14. The deaeration valve according to claim 13, wherein the first end has an essentially spherical shape and the second end has an essentially spherical shape, and wherein the radius of the first end is smaller than the radius of the second end.

15. The deaeration valve according to claim 13, wherein a slit is formed between the intermediate portion and the valve housing for allowing pressurized air to flow freely from the inlet port to the outlet port when the valve member is moving from the idle closed end position towards the actuated closed end position.

16. The deaeration valve according to claim 12, wherein the valve is configured to open for letting pressurized air pass when the pressure on the inlet port is in the range of 5-40 bar(g), whereby the valve member moves from its idle closed end position to the actuated closed end position.

17. The deaeration valve according to claim 16, wherein the valve member is configured to return from the actuated closed end position to the idle closed end position when the pressure falls by approximately a factor 2-10 relative the pressure required for opening of the valve.

18. The deaeration valve according to claim 17, wherein the ratio of the surface area of the valve member that the air pressure is acting on via the inlet port when the valve member is in its idle closed position and its actuated closed position, respectively is approximately 2 to 10.

19. A hydraulic coupling for distributing torque in a vehicle, comprising a deaeration valve, a valve member and a valve housing, the valve housing supporting the valve member for reciprocal movement between an idle closed end position and an actuated closed end position, wherein the valve member is biased towards the idle closed end position, such that when the valve member is subjected to an increased pressure, pressurized air will be allowed to escape through the valve.

20. A method for deaeration of a hydraulic system for a hydraulic coupling, such as a hydraulic coupling for distributing torque in a vehicle, comprising the step of providing a valve having a valve member and a valve housing, the valve housing supporting a valve member for reciprocal movement between two closed end positions, wherein the valve member is biased towards one of said closed end positions, and the step of subjecting the valve member to an increased pressure whereby pressurized air will be allowed to escape through the valve.
